(19) United States
(12) Patent Application Publication
(10) Pub. No.: US 2011/0216193 A1
(43) Pub. Date: Sep. 8, 2011

(54) MONITORING CAMERA

(75) Inventor: Hyung-rok SHIM, Changwon-city (KR)

(73) Assignee: SAMSUNG TECHWIN CO., LTD., Changwon-city (KR)

(21) Appl. No.: 13/038,971

(22) Filed: Mar. 2, 2011

(30) Foreign Application Priority Data
Mar. 3, 2010 (KR) 10-2010-0019033

(51) Int. Cl. H04N 7/18; G03B 15/00

(52) U.S. Cl. 348/143; 396/351; 348/E07.085

(57) ABSTRACT

A monitoring camera including: a rotational base which is configured to rotate about a rotational axis, with respect to a fixed base; a camera barrel which is coupled to the rotational base and changes an optical path of light input from an outside into a longitudinal direction of the camera barrel which is substantially parallel with a surface of the rotational base which is substantially perpendicular to the rotational axis, and the camera barrel tilts about an axis of the longitudinal direction of the camera barrel; and a housing which includes a window, formed on a surface of the housing, through which the light is input to the camera barrel, and encloses the camera barrel and the rotational base.

### CROSS-REFERENCE TO RELATED PATENT APPLICATION

This application claims priority from Korean Patent Application No. 10-2010-0019033, filed on Mar. 3, 2010, the disclosure of which is incorporated herein in its entirety by reference.

### BACKGROUND

1. Field

Apparatuses consistent with exemplary embodiments relate to monitoring cameras, and more particularly, to monitoring cameras using a camera barrel as a refractive optical system.

2. Description of the Related Art

In general, a monitoring camera is classified into a standard camera, a zoom camera, a dome camera, a speed dome (SPD) camera, and the like. Since the dome camera is installed to match with an interior space, and is fixed to a base structure, the dome camera photographs only a single place, that is, a limited place. In order to overcome this problem, the SPD camera for changing a monitored space has been used.

However, the SPD camera is installed to protrude about 25 cm from a ceiling. Thus, the SPD camera may not be installed in a space having a low ceiling. In addition, since the SPD camera may be easily noticed, the SPD camera is vulnerable to security. Accordingly, the SPD camera may not be easily installed indoors, for example, in a place requiring the SPD camera, and a typical short focus lens or a mirror may be used. If a monitoring camera needs to be unnoticeable, the SPD camera may not be installed indoors and outdoors since the SPD camera protrudes from a ceiling.

### SUMMARY

One or more exemplary embodiments provide monitoring cameras with a reduced height, which may be installed in a limited space, and may be unnoticeable.

According to an aspect of an exemplary embodiment, there is provided a monitoring camera including: a rotational base which is configured to rotate about a rotational axis, with respect to a fixed base; a camera barrel which is coupled to the rotational base and changes an optical path of light input from an outside into a longitudinal direction of the camera barrel which is substantially parallel with a surface of the rotational base which is substantially perpendicular to the rotational axis, and the camera barrel tilts about an axis of the longitudinal direction of the camera barrel; and a housing which comprises a window, formed on a surface of the housing, through which the light is input to the camera barrel, and encloses the camera barrel and the rotational base.

The camera barrel may include: a first lens portion through which the light is input to the camera barrel; an optical element which changes the optical axis of the light input through the first lens portion by refracting the light; and a photoelectric transformer which transforms an image, indicated by the light refracted by the optical element, into an electrical signal. In addition, the camera barrel may further include a second lens portion which is disposed between the optical element and the photoelectric transformer to adjust optical properties of the light refracted by the optical element.

The second lens portion may include a plurality of lenses which adjust a focus of the light refracted by the optical element, or magnify the image indicated by the light.

The rotational base may be a printed circuit board (PCB) which forms a circuit pattern or mounts an electronic device thereon.

The window of the housing may be formed of glass.

The camera barrel may be a zooming camera barrel.

The rotational base may rotate at an angle equal to or less than 360°.

The camera barrel may tilt at an angle equal to or less than 180°.

The monitoring camera may further include a fixed base, the rotational base, and the camera barrel may be configured to be disposed in a cavity formed in the supporter.

The monitoring camera may further include a first motor which drives the rotational base; a second motor which drives the camera barrel; and a controller which controls the first motor and the second motor.

The first motor, the second motor, and the controller may be coupled to the rotational base.

A direction of a rotational axis of the rotational base is substantially perpendicular to a direction of a tilting axis of the camera barrel.

The housing may be coupled to the rotational base to simultaneously rotate as the rotational base rotates.

The fixed base may be coupled to the supporter by a fixing member.

### BRIEF DESCRIPTION OF THE DRAWINGS

The above and other aspects will become more apparent by describing in detail exemplary embodiments thereof with reference to the attached drawings in which:

FIG. 1 is an exploded perspective view of a monitoring camera according to an exemplary embodiment;

FIG. 2 is a side view of the monitoring camera of FIG. 1, according to an exemplary embodiment;

FIG. 3 is a perspective view of a camera barrel of the monitoring camera of FIG. 1, according to an exemplary embodiment;

FIG. 4 is a schematic diagram of the camera barrel of the monitoring camera of FIG. 1, according to an exemplary embodiment;

FIGS. 5 through 7 are side views for explaining cases where a monitoring camera tilts in the monitoring camera of FIG. 1, according to an exemplary embodiment; and

FIG. 8 is a side view of a monitoring camera according to an exemplary embodiment.

### DETAILED DESCRIPTION OF EXEMPLARY EMBODIMENTS

Exemplary embodiments will now be described more fully with reference to the accompanying drawings. The inventive concept may, however, be embodied in many different forms and should not be construed as being limited to the exemplary embodiments set forth herein; rather, these exemplary embodiments are provided so that this disclosure will be thorough and complete, and will fully convey the inventive concept to those skilled in the art. Also, while describing the exemplary embodiments, detailed descriptions about related well-known functions or configurations that may diminish the clarity of the points of the exemplary embodiments are omitted.

The terminology used herein is for the purpose of describing the exemplary embodiments only and is not intended to be limiting the example embodiments.

As used herein, the singular forms “a,” “an” and “the” are intended to include the plural forms as well, unless the context clearly indicates otherwise. It will be further understood that the terms “comprises” and/or “comprising” used herein specify the presence of stated features, integers, steps, operations, members, components, and/or groups thereof, but do not preclude the presence or addition of one or more other features, integers, steps, operations, members, components, and/or groups thereof.

Hereinafter, a monitoring camera will be described with regard to the exemplary embodiments with reference to the attached drawings. In the drawings, the same elements are denoted by the same reference numerals, and a repeated explanation thereof will not be given.

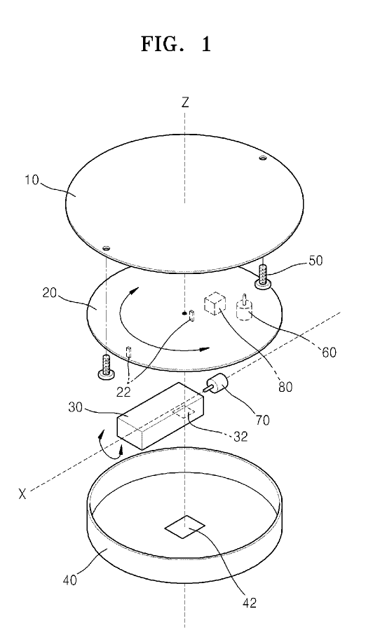

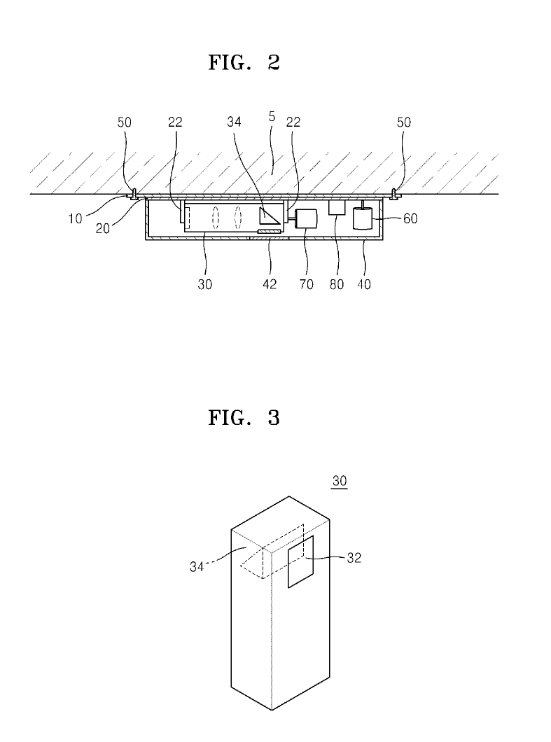

FIG. 1 is an exploded perspective view of a monitoring camera according to an exemplary embodiment. FIG. 2 is a side view of the monitoring camera of FIG. 1. FIGS. 1 and 2 illustrate a supporter 5, a fixed base 10, a rotational base 20, a camera barrel 30, a housing 40, a fixing member 50, a first motor 60, a second motor 70, and a controller 80.

The monitoring camera is fixed to the supporter 5 such as a ceiling, a wall, or the like, and is a device for monitoring or checking an object around the monitoring camera. The monitoring camera displaying an image of an external object by using light emitted from an outside of the monitoring camera. The monitoring camera may be configured to have a wide view angle so as to monitor all objects around the monitoring camera.

The monitoring camera includes the fixed base 10 fixed to the supporter 5, as illustrated in FIG. 1. The fixed base 10 is a base component for firmly fixing a body of the monitoring camera to the supporter 5 such as a substantial structure. The fixed base 10 may be coupled and fixed to the supporter 5, and may be a wide substrate to which other components of the monitoring camera are fixed, as illustrated in FIG. 1. In FIG. 1, the fixed base 10 has a circular shape. Alternatively, the fixed base 10 may be an oval or polygonal-shaped plate with a predetermined area that may be used as a base substrate of the monitoring camera, and may be firmly fixed to the supporter 5. In addition, the fixed base 10 may be installed and fixed onto a wall by using the fixing member 50 such as a bolt or the like.

As illustrated in FIG. 1, the rotational base 20 is fixed to the fixed base 10. The rotational base 20 rotates around one axis (i.e., a Z-axis) of a central portion of the monitoring camera. The rotational base 20 is coupled to the fixed base 10 to rotate with respect to the fixed base 10 fixed to the supporter 5. According to an exemplary embodiment, a center of rotation of the rotational base 20 is rotatably coupled to the fixed base 10 so that the rotational base 20 shaped like a circular plate may rotate. The rotational base 20 has a circular shape, in FIG. 1. However, the rotational base 20 may have any shape of a wide substrate that may accommodates components of the monitoring camera, such as the camera barrel 30, the first and second motors 60 and 70, and the like, which will be described later.

The camera barrel 30 is coupled to the rotational base 20. According to an exemplary embodiment, the camera barrel 30 may be a refractive optical system for changing an optical path of light input to the optical system, by using a prism. That is, the refractive optical system changes the optical path of the light, and collects the light originally emitted from an external object. Specifically, the optical path is changed in a direction perpendicular to a direction in which the light is input to the optical system as the light is refracted by the prism in the camera barrel 30. More specifically, the light is input to a first lateral surface of the camera barrel 30, and an optical path of the input light is changed to a longitudinal direction of the camera barrel 30.

The camera barrel 30 is coupled to a bottom surface of the rotational base 20. Specifically, as illustrated in FIGS. 1 and 2, a second lateral surface, opposite to the first lateral surface, of the camera barrel 30 may be coupled to the surface of the rotational base 20 so that a light input surface of a lens formed on the first lateral surface of the camera barrel 30 may face a direction opposite to a direction toward the bottom surface of the rotational base 20. Thus, the camera barrel 30 may be configured to capture an image of the external object which is located in a place opposite to the bottom surface of the rotational base 20 with respect to the camera barrel 30, as illustrated in FIG. 2.

The camera barrel 30, of which the second lateral surface is coupled to the rotational base 20, is tilted about an axis at a predetermined angle with respect to the bottom surface the rotational base 20 to obtain a wider view angle. As illustrated in FIGS. 1 and 2, the rotational base 20 may include connecting arms 22 for respectively connecting both longitudinal ends of the camera barrel 30, in the longitudinal direction, to the rotational base 20, and the connecting arms 22 may be hinged to the both longitudinal ends of the camera barrel 30 to obtain rotational degrees of freedom. The axis (i.e., an X-axis) about which the camera barrel 30 is tilted may be an axis that is disposed in parallel to the longitudinal direction of the camera barrel 30, as illustrated in FIG. 1. As the camera barrel 30 is tilted right and left about the axis of the longitudinal direction of the camera barrel 30 at predetermined angles, a view angle of the camera barrel 30 is increased, and a scope of objects to be photographed by the monitoring camera may be widened.

The housing 40 may be installed to cover the camera barrel 30 and the rotational base 20. The housing 40 may protect internal components of the monitoring camera. A window 42 is formed in a central portion of the housing 40, as illustrated in FIGS. 1 and 2, and passes light input to the camera barrel 30 therethrough. That is, the camera barrel 30 may capture an image of the external object of the monitoring camera through the window 42. According to an exemplary embodiment, the window 42 may be formed of transparent glass.

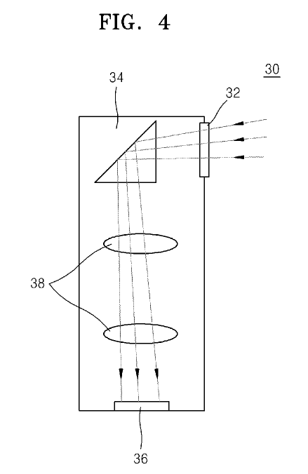

The camera barrel 30 of the monitoring camera will be described in detail with reference to FIGS. 3 and 4. FIG. 3 is a perspective view of the camera barrel 30 of the monitoring camera of FIG. 1. FIG. 4 is a schematic diagram of the camera barrel 30 of the monitoring camera of FIG. 1. FIGS. 3 and 4 illustrate a first lens portion 32, a prism 34, a photoelectric transformer 36, and a second lens portion 38.

FIGS. 3 and 4 show that the camera barrel 30 is a refractive type optical system as described above in reference to FIG. 2, and includes the photoelectric transformer 36, the first lens portion 32, and the second lens portion 38.

The first lens portion 32 is a portion of the camera barrel 30 through which light is first input, is formed on the first lateral surface of the camera barrel 30, and transmits the input light to the prism 34.

The prism 34 refracts the light input through the first lens portion 32, and changes an optical path in a direction perpendicular to a direction in which the light is input.

The second lens portion 38 includes a plurality of lenses, and is disposed between the prism 34 and the photoelectric transformer 36 to perform a zooming operation on the image formed on the photoelectric transformer 36 and adjust a focus of the image. The lenses of the second lens portion 38 may perform the zooming operation on the image and adjust the focus of the image while moving forwards and backwards in the camera barrel 30. In this case, the number of the second lens portion 38 is not particularly limited as long as the number may be easily changed by one of ordinary skill in the art. That is, the camera barrel 30 may be variously designed to perform the zooming operation. For instance, the second lens portion 38 may comprise three or four lens groups, or may have a movable lens group together with a fixed lens group. In addition, the second lens portion 38 may have a fixed magnification ratio, or may have a zooming capability.

The photoelectric transformer 36 includes an optical low pass filter and a charge coupled device, and transforms the light representing the image of the external object into an electrical signal.

As described above, the camera barrel 30 is configured as a refractive type optical system in which the light is input to the camera barrel 30, and then, the optical axis is changed in the direction perpendicular to the direction in which the light is input, by the prism 34. That is, the optical axis of the light input through the first lens portion 32 is changed by 90° by the prism 34, and the light passes through the second lens portion 38. The light of which the focus is adjusted by distances between the lenses of the second lens portion 38 is incident on the photoelectric transformer 36. That is, since the camera barrel 30 is configured to change the optical axis of the light by 90° without having the lenses of the second lens portion 38 disposed on the optical path before it is changed by the prism 34, thickness of the monitoring camera, in the Z-axis, may be remarkably reduced.

An external appearance of the camera barrel 30 has a square pillar shape, as illustrated in FIGS. 3 and 4, but is not limited thereto. That is, the camera barrel 30 may have any shape as long as the shape may be easily changed by one of ordinary skill in the art.

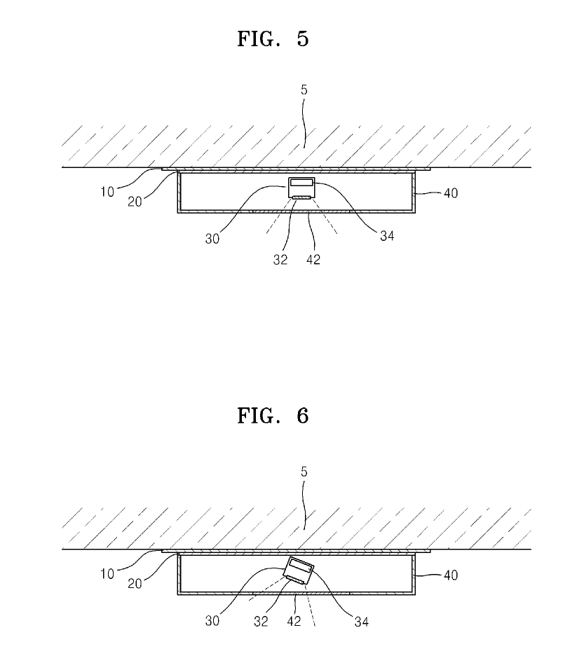

The camera barrel 30 is coupled to the rotational base 20 to tilt, as illustrated in FIGS. 5 through 7. FIGS. 5 through 7 are side views of the monitoring camera viewed in the longitudinal direction (X-axis) of the camera barrel 30. According to an exemplary embodiment, the both longitudinal ends of the camera barrel 30 may be coupled to the rotational base 20 to support a tilt operation of the camera barrel 30.

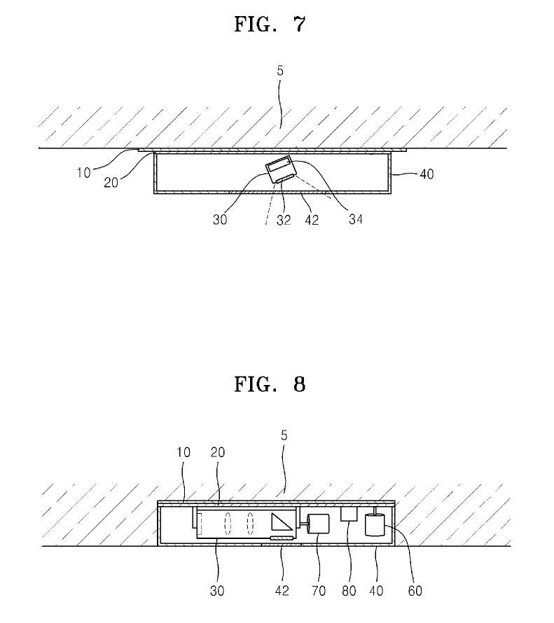

FIG. 5 illustrates a case where the camera barrel 30 is not tilted, when viewed in the longitudinal direction. FIG. 6 illustrates a case where the camera barrel 30 is tilted to the left by a predetermined angle. FIG. 7 illustrates a case where the camera barrel 30 is tilted right by a predetermined angle. Since the camera barrel 30 is tilted right and left about the axis (i.e., X-axis) of the longitudinal direction of the camera barrel 30 at predetermined angles, a view angle of the camera barrel 30 is increased for checking an object located below the supporter 5. In this case, the window 42 formed in the housing 40 has a predetermined width to provide the view angle of the camera barrel 30. According to an exemplary embodiment, in FIGS. 5 through 7, the camera barrel 30 may tilt at an angle equal to or less than 180°, and thus a monitoring scope of the monitoring camera may be increased.

According to an exemplary embodiment, the camera barrel 30 may tilt right and left at an angle equal to or less than 180°, and simultaneously the rotational base 20 may rotate at an angel equal to or less than 360°. Referring to FIG. 1, the rotational axis (i.e., Z-axis) of the rotational base 20 and the tilting axis (i.e., X-axis) of the camera barrel 30 is perpendicular to each other. Thus, the camera barrel 30 may be controlled to face all objects around the monitoring camera.

As illustrated in FIG. 1, the rotational base 20 to which the camera barrel 30 is coupled rotates about the axis (i.e., Z-axis) of the central portion of the rotational base 20. Simultaneously, the camera barrel 30 and the housing 40, which are coupled to the rotational base 20, may also rotate. Thus, by adjusting the rotational angle of the rotational base 20, and the tilting angle of the camera barrel 30, all objects around the monitoring camera may be checked. Thus, the view angle of the monitoring camera may be widened in all directions.

According to an exemplary embodiment, by using the camera barrel 30 that is a refractive optical system of which the first lateral surface is coupled to the rotational base 20 (bottom surface) to tilt, an entire height of the monitoring camera in the direction of the Z-axis may be reduced. That is, by using the camera barrel 30 of a refractive type in which many of the lenses of the camera barrel 30 do not have to be disposed on the optical path before it is changed by the prism 34 in the camera barrel 30, the height of the monitoring camera may be remarkably reduced. Thus, the height of a portion of the monitoring camera that protrudes from the supporter 5 is reduced, and the monitoring camera is not noticeable. According to an exemplary embodiment, the height of the monitoring camera may be about 5 cm.

The first motor 60 is a driver for rotating the rotational base 20, and the second motor 70 is a driver for tilting the camera barrel 30. Power generated by the first motor 60 and the second motor 70 may be transferred to the rotational base 20 and the camera barrel 30 through a power transfer apparatus (not shown) such as a chain, a timing belt, or a gear, and may be used to move the rotational base 20 and the camera barrel 30. The power transfer apparatus is not particularly limited, and may be any apparatus that converts rotary forces of the first and second motors 60 and 70 into rotation of the rotational base 20 and the tilt of the camera barrel 30.

The controller 80 checks states of the rotational base 20 and the camera barrel 30 to control the first motor 60 and the second motor 70. The controller 80 may be an electronic device that may control electrons and transmit control signals.

The first motor 60, the second motor 70, and the controller 80 are coupled to the rotational base 20 to move according to the rotation of the rotational base 20. The rotational base 20 may use a printed circuit board (PCB) for electrically connecting the first and second motors 60 and 70 to the controller 80. That is, circuit patterns formed on the rotational base 20 function as paths for transmitting the control signals transmitted from the controller 80 to the first and second motors 60 and 80. In addition, the controller 80 may be mounted on the rotational base 20 to receive various electrical signals from an external device.

According to an exemplary embodiment, the camera barrel 30, the first motor 60, the second motor 70, and the controller 80 are coupled to the rotational base 20 including circuit patterns, and the housing 40 covers the resultant structure, thereby completing the manufacture of the monitoring camera that rotates according to the rotation of the rotational base 20. In addition, various electronic devices and components required to operate the monitoring camera may be accommodated in the housing 40.

According to an exemplary embodiment, a monitoring camera may be embedded in the supporter 5. As illustrated in FIG. 8, a cavity is formed in the supporter 5 so as to accommodate the monitoring camera. While the fixed base 10 is fixed in the cavity, the rotational base 20, the camera barrel 30, the first motor 60, the second motor 70, and the controller 80 may be installed to cover the fixed base 10. The housing 40 may cover the rotational base 20, and the camera barrel 30. In this case, a bottom surface of the housing 40 and a surface of the supporter 5 constitute the same plane to face the external object. Thus, the monitoring camera is not exposed so that a bottom surface of the monitoring camera is noticed as the same as a surface of a ceiling or wall, and thus, may be unnoticeable. According to this exemplary embodiment, the monitoring camera may be barely noticed.

In a typical monitoring camera, a top surface of a camera barrel faces a rotational base, and the camera barrel tilt up and down to ensure a view angle. Thus, an area for moving the camera barrel is increased, thereby increasing the size of the monitoring camera. However, according to the above exemplary embodiments, since the camera barrel 30 of a refractive type tilts around the axis of the longitudinal direction, a wide space for the tilting is not required, thereby remarkably reducing the space for the tilting and a space for installing the monitoring camera. In addition, by slightly moving the camera barrel 30, the view angle of the monitoring camera may be adjusted, and thus, an operational speed of the monitoring camera may be increased. In summary, according to the above exemplary embodiments, the monitoring camera may be rendered thin, and have a high operational speed while ensuring a wide view angle.

According to the above exemplary embodiments, the height of a monitoring camera may be reduced by using a camera barrel as a refractive type optical system, and thus, the monitoring camera may be barely noticed, and an operational speed of the monitoring camera may be increased.

While the inventive concept has been particularly shown and described with reference to the above exemplary embodiments thereof, it will be understood by those of ordinary skill in the art that various changes in form and details may be made therein without departing from the spirit.

For instance, in the above exemplary embodiments, the housing 40 is coupled to the rotational base 20 and rotates together with the rotational base 20, the housing 40, however, may be coupled with the fixed base 10. In other words, the housing 40 may remain stationary and the rotational base 20 in the housing 40 may rotate independently of the housing 40.

Other than the above exemplary embodiments explained above, there are many possible embodiments within the scope of the inventive concept as defined by the following claims.

1. A monitoring camera comprising:
a rotational base which is configured to rotate about a rotational axis, with respect to a fixed base;
a camera barrel which is coupled to the rotational base and changes an optical path of light input from an outside into a longitudinal direction of the camera barrel which is substantially parallel with a surface of the rotational base which is substantially perpendicular to the rotational axis, and the camera barrel tilts about an axis of the longitudinal direction of the camera barrel; and
a housing which comprises a window, formed on a surface of the housing, through which the light is input to the camera barrel, and encloses the camera barrel and the rotational base.

2. The monitoring camera of claim 1, wherein the camera barrel comprises:
a first lens portion through which the light is input to the camera barrel;
an optical element which changes the optical axis of the light input through the first lens portion by refracting the light; and
a photoelectric transformer which transforms an image, indicated by the light refracted by the optical element, into an electrical signal.

3. The monitoring camera of claim 2, wherein the camera barrel further comprises a second lens portion which is disposed between the optical element and the photoelectric transformer to adjust optical properties of the light refracted by the optical element.

4. The monitoring camera of claim 3, wherein the second lens portion comprises a plurality of lenses which adjust a focus of the light refracted by the optical element, or magnify the image indicated by the light.

5. The monitoring camera of claim 1, wherein the rotational base is a printed circuit board (PCB) which forms a circuit pattern or mounts an electronic device thereon.

6. The monitoring camera of claim 1, wherein the window of the housing comprises glass.

7. The monitoring camera of claim 1, wherein the camera barrel is a zooming camera barrel.

8. The monitoring camera of claim 1, wherein the rotational base rotates at an angle equal to or less than 360°.

9. The monitoring camera of claim 1, wherein the camera barrel tilts at an angle equal to or less than 180°.

10. The monitoring camera of claim 1, further comprising the fixed base, wherein the fixed base, the rotational base, and the camera barrel are configured to be disposed in a cavity formed in a supporter.

11. The monitoring camera of claim 1, further comprising:
a first motor which drives the rotational base;
a second motor which drives the camera barrel; and
a controller which controls the first motor and the second motor.

12. The monitoring camera of claim 11, wherein the first motor, the second motor, and the controller are coupled to the rotational base.

13. The monitoring camera of claim 1, wherein a direction of a rotational axis of the rotational base is substantially perpendicular to a direction of a tilting axis of the camera barrel.

14. The monitoring camera of claim 1, wherein the housing is coupled to the rotational base.

15. The monitoring camera of claim 1, wherein the fixed base is coupled to a supporter by a fixing member.

16. The monitoring camera of claim 1, wherein the housing is coupled to the fixed base.

17. The monitoring camera of claim 1, wherein the camera barrel comprises a first lens, through which the light is input to the camera barrel, and at least one second lens which is disposed along the longitudinal axis to perform at least one of zooming and focusing of the light, and
wherein the optical path of the light input from the outside through the first lens, before the optical path is changed in the camera barrel, is substantially parallel with the rotational axis of the rotational base.

18. The monitoring camera of claim 17, wherein the camera barrel further comprises:
an optical element which changes the optical axis of the light input through the first lens by refracting the light; and
a photoelectric transformer which transforms an image, indicated by the light refracted by the optical element, into an electrical signal.
